(19) United States
(12) Patent Application Publication
(10) Pub. No.: US 2026/0164254 A1
(43) Pub. Date: Jun. 11, 2026

(54) Verification System and Verification Method

(71) Applicant: Daifuku Co., Ltd., Osaka-shi (JP)

(72) Inventors: Daisuke Ogawa, Hinocho (JP); Yuya Hirao, Hinocho (JP); Kosuke Kimura, Hinocho (JP)

(21) Appl. No.: 19/179,456

(22) Filed: Apr. 15, 2025

(30) Foreign Application Priority Data
Apr. 16, 2024 (JP) 2024-066118

(51) Int. Cl. H04W 16/18; H04W 16/24; H04W 24/08

(52) U.S. Cl. CPC H04W 16/18; H04W 16/24; H04W 24/08

(57) ABSTRACT

A verification system includes a reference field intensity setter, a field intensity obtainer, and a verification processor. The reference field intensity setter sets a reference radio field intensity at each of a plurality of observation sites in a target area. The field intensity obtainer obtains observation-site field-intensity information indicating at least one of a predictive value of a radio field intensity calculated for each observation site or a measurement value of the radio field intensity measured for each observation site. The verification processor performs a verification process based on the observation-site field-intensity information. The verification process includes a removable-access-point extraction process for extracting a removable wireless access point that is removable while satisfying a field intensity condition. The field intensity condition is satisfied when the radio field intensity at all the plurality of observation sites is higher than or equal to the reference radio field intensity.

### CROSS-REFERENCE TO RELATED APPLICATION

This application claims priority to Japanese Patent Application No. 2024-066118 filed Apr. 16, 2024, the disclosure of which is hereby incorporated by reference in its entirety.

### BACKGROUND OF THE INVENTION

### Field of the Invention

The present invention relates to a verification system and a verification method for a wireless communication system.

### Description of Related Art

An example of a wireless communication system is described in Japanese Unexamined Patent Application Publication No. 2022-160219 (JP 2022-160219). In the background described hereafter, reference signs in parentheses are the reference signs in JP 2022-160219. The wireless communication system described in JP 2022-160219 includes multiple wireless access points (AP) to perform wireless communication with terminals (T). In JP 2022-160219, the wireless access points (AP) are arranged in a target area including a wall surface (Sw) at least surrounding the area based on reflection of radio waves off the wall surface (Sw). More specifically, as shown in FIG. 7 in JP 2022-160219, the radius (Rca1) of a cover area of each wireless access point (AP) in the area including the wall surface (Sw) is set larger than the radius (Rca2) of a cover area of each wireless access point (AP) in an area not including the wall surface (Sw). These radii (Rca1 and Rca2) are used to arrange the wireless access points (AP) as appropriate for the target area. In JP 2022-160219,such arrangement of the wireless access points (AP) can optimize the number of wireless access points (AP) in the target area.

Radio waves propagated in a target area (an area provided with radio waves from wireless access points) are typically affected by various objects such as equipment disposed in the target area, in addition to the wall referred to in JP 2022-160219. The degree of affecting the radio waves can vary object to object (e.g., based on the material of the wall surface), although the objects are of the same type. Thus, simply varying the radius of the cover area based on whether a wall surface is included as with the technique described in JP 2022-160219 may not optimize the arrangement of the wireless access points, and may place, for example, more wireless access points than used. Among such more wireless access points than used, unused wireless access points may be omitted to reduce radio wave interference or costs. Thus, the arrangement of wireless access points may be verified to appropriately extract any wireless access point that is removable. JP 2022-160219 describes no such verification.

### SUMMARY OF THE INVENTION

Techniques are awaited for verifying the arrangement of wireless access points and appropriately extracting a wireless access point that is removable.

A verification system according to an aspect of the disclosure is a system for a wireless communication system. The wireless communication system includes a plurality of wireless access points arranged to provide radio waves to a target area to perform wireless communication with a movable body movable in the target area. The verification system includes a reference field intensity setter, a field intensity obtainer, and a verification processor. The reference field intensity setter sets a reference radio field intensity that is a reference value of a radio field intensity provided from the wireless communication system at each of a plurality of observation sites in the target area. The field intensity obtainer obtains observation-site field-intensity information indicating at least one of a predictive value of the radio field intensity provided from each of the plurality of wireless access points or a measurement value of the radio field intensity provided from each of the plurality of wireless access points. The predictive value is calculated for each of the plurality of observation sites based on layout information and arrangement information. The measurement value is measured for each of the plurality of observation sites. The layout information includes information indicating a shape of the target area and information indicating a position of an object affecting propagation of the radio waves in the target area. The arrangement information indicates arrangement of the plurality of wireless access points. The verification processor performs a verification process for the arrangement of the plurality of wireless access points based on the observation-site field-intensity information. The verification process includes a removable-access-point extraction process for extracting, from the plurality of wireless access points, a removable wireless access point that is removable while satisfying a field intensity condition. The field intensity condition is satisfied when the radio field intensity at all the plurality of observation sites is higher than or equal to the reference radio field intensity.

A verification method according to an aspect of the disclosure is a method for a wireless communication system including a plurality of wireless access points arranged to provide radio waves to a target area to perform wireless communication with a movable body movable in the target area. The method includes setting a reference radio field intensity, obtaining observation-site field-intensity information, and performing a verification process. The setting includes setting the reference radio field intensity that is a reference value of a radio field intensity provided from the wireless communication system at each of a plurality of observation sites in the target area. The obtaining includes obtaining the observation-site field-intensity information indicating at least one of a predictive value of the radio field intensity provided from each of the plurality of wireless access points or a measurement value of the radio field intensity provided from each of the plurality of wireless access points. The predictive value is calculated for each of the plurality of observation sites based on layout information and arrangement information. The measurement value is measured for each of the plurality of observation sites. The layout information includes information indicating a shape of the target area and information indicating a position of an object affecting propagation of the radio waves in the target area. The arrangement information indicates arrangement of the plurality of wireless access points. The performing includes performing the verification process for the arrangement of the plurality of wireless access points based on the observation-site field-intensity information. The verification process includes a removable-access-point extraction process for extracting, from the plurality of wireless access points, a removable wireless access point that is removable while satisfying a field intensity condition. The field intensity condition is satisfied when the radio field intensity at all the plurality of observation sites is higher than or equal to the reference radio field intensity.

The verification system and the verification method according to the above aspects perform the verification process for the arrangement of the plurality of wireless access points based on the observation-site field-intensity information indicating the radio field intensity at each observation site. This allows a removable wireless access point to be extracted appropriately in the removable-access-point extraction process included in the verification process. The observation-site field-intensity information indicates at least one of the predictive value of the radio field intensity calculated for each observation site or the measurement value of the radio field intensity measured for each observation site. Thus, removable wireless access points can be extracted appropriately independently of whether the wireless access points are actually installed. As described above, the verification system and the verification method according to the aspects can verify the arrangement of multiple wireless access points and appropriately extract a wireless access point that is removable.

Further aspects and features of the verification system and the verification method will be apparent from embodiments described below with reference to the drawings.

### BRIEF DESCRIPTION OF THE DRAWINGS

The terms Fig., Figs., Figure, and Figures are used interchangeably in the specification to refer to the corresponding figures in the drawings.

FIG. 1 is a diagram of an example target area.

FIG. 2 is a diagram of an example movable body.

FIG. 3 is a block diagram of a verification system according to an embodiment.

FIG. 4 is a diagram of example observation sites.

FIG. 5 is a flowchart of a preprocess and a verification process in the embodiment.

FIG. 6 is a flowchart of a removable-access-point extraction process in the embodiment.

FIG. 7 is a diagram of three examples (a first example, a second example, and a third example) of a communication area for each access point.

FIG. 8 is a diagram describing the removable-access-point extraction process in the first example.

FIG. 9 is a diagram describing the removable-access-point extraction process in the first example.

FIG. 10 is a diagram describing the removable-access-point extraction process in the first example.

FIG. 11 is a diagram describing the removable-access-point extraction process in the first example.

FIG. 12 is a diagram describing the removable-access-point extraction process in the second example.

FIG. 13 is a diagram describing the removable-access-point extraction process in the second example.

FIG. 14 is a diagram describing the removable-access-point extraction process in the second example.

FIG. 15 is a diagram describing the removable-access-point extraction process in the second example.

FIG. 16 is a diagram describing the removable-access-point extraction process in the third example.

FIG. 17 is a diagram describing the removable-access-point extraction process in the third example.

FIG. 18 is a diagram describing the removable-access-point extraction process in the third example.

FIG. 19 is a diagram describing the removable-access-point extraction process in the third example.

### DESCRIPTION OF THE INVENTION

A verification system for a wireless communication system and a verification method for a wireless communication system according to one or more embodiments will be described with reference to the drawings. Although the verification system is mainly described below, various technical features of the verification system described herein are applicable to a verification method or a verification program (a program for causing a computer to function as a verification system). In addition to the verification system, the verification method, and the verification program, a storage medium (e.g., a computer-readable recording medium such as an optical disc or a flash memory) storing the verification program is also described herein.

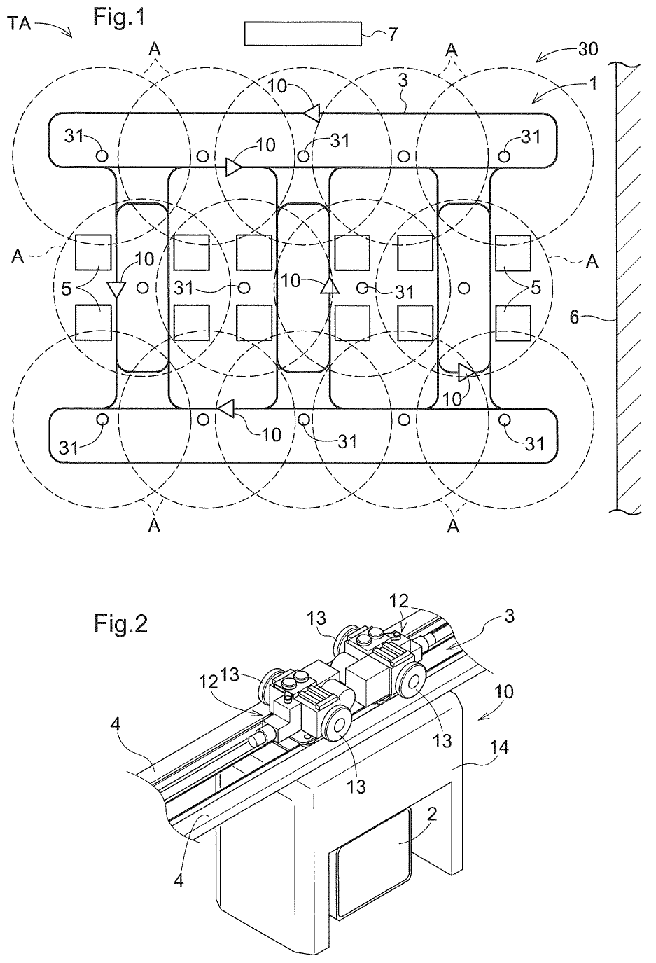

A verification system 40 verifies a wireless communication system 30. As shown in FIG. 1, the wireless communication system 30 includes multiple wireless access points 31 arranged to provide radio waves to a target area TA. In the target area TA, at least one movable body 10 (described later) is movable. In the example shown in FIG. 1, all the wireless access points 31 are arranged in the target area TA. However, when the wireless access points 31 are arranged to provide radio waves to the target area TA, at least one of the wireless access points 31 may be arranged outside the target area TA. The radio waves herein refer to electromagnetic waves for wireless communication. The radio waves are not limited to electromagnetic waves of a specific frequency band. In the present embodiment, for example, the radio waves are electromagnetic waves at frequencies used in a wireless local area network (LAN).

The wireless communication system 30 performs wireless communication with the movable body 10 that moves in the target area TA. More specifically, any of the wireless access points 31 connected to the movable body 10 to communicate with the movable body 10 performs wireless communication with the movable body 10. In the present embodiment, the wireless communication system 30 performs wireless communication with multiple movable bodies 10 moving in the target area TA. Each movable body 10 includes a communication module that can perform wireless communication with the wireless access points 31. The movable body 10 establishes a communication link with any of the wireless access points 31 (e.g., a wireless access point 31 providing the highest radio field intensity) to be connected to communicate with the wireless access point 31. While moving, the movable body 10 switches the wireless access point 31 with which the movable body 10 establishes a communication link (performs roaming). FIG. 1 simply shows, with circles each centered at the corresponding wireless access point 31, communication areas A to which a radio field intensity higher than or equal to a reference radio field intensity is provided from the wireless access points 31 (in other words, at which radio waves with an intensity higher than or equal to the reference radio field intensity arrive). The radio field intensity is indicated by, for example, a numerical value of received signal strength indicator (RSSI).

In the present embodiment, the movable body 10 moves in a self-propelled manner. The movable body 10 thus includes a power source (e.g., an electric motor) for moving. The movable body 10 moves, for example, autonomously or by remote operation. In the present embodiment, as shown in FIG. 2, the movable body 10 is an article transporter, which moves to transport an article 2. Examples of the article transporter include an article transport vehicle shown in FIG. 2 and an air vehicle for transporting articles (e.g., a drone). The movable body 10 may move for purposes other than transporting the article 2 (e.g., for monitoring or information gathering). The target area TA in which the movable body 10 moves may be an outdoor area (outside a building), but in the present embodiment, the target area TA is an indoor area (inside a building).

The article transport vehicle as the movable body 10 shown in FIG. 2 is a ceiling-hung transport vehicle that travels along rails 4 hung from the ceiling. The movable body 10 includes a traveler 12 including travel wheels 13 that roll on travel surfaces of the rails 4, and a body 14 connected to the traveler 12. The travel wheels 13 are driven by a power source such as an electric motor to rotate, thus causing the traveler 12 to travel along the rails 4. The movable body 10 thus moves along a travel path 3 defined by the rails 4. The article 2 contained in the body 14 is transported by the movable body 10. The article 2 is, for example, a front opening unified pod (FOUP) containing semiconductor wafers. The article transport vehicle as the movable body 10 is not limited to a ceiling-hung transport vehicle, but may be a tracked transport vehicle that travels along rails on a floor surface or a trackless transport vehicle such as an automated guided vehicle (AGV) or an autonomous mobile robot (AMR). When the movable body 10 is a trackless transport vehicle, the travel path 3 of the movable body 10 is defined to connect, for example, multiple detectable members (two-dimensional codes or radio frequency tags) installed on the floor surface or defined freely based on calculation using recognition results of the surrounding environment.

FIG. 1 shows, as an example facility to which the wireless communication system 30 is applied, a transport facility 1 in which the movable body 10 transports the article 2 (refer to FIG. 2). FIGS. 1 and 4 are plan layouts (layouts in a plan view) of the transport facility 1, in which the direction orthogonal to the page of each figure corresponds to the vertical direction (height direction). In the example shown in FIG. 1, multiple devices 5 are included in the target area TA. The travel path 3 of the movable body 10 is predetermined to pass through the devices 5. Examples of the devices 5 include a processing device for processing the article 2 (or an object contained in the article 2), and a storage device that stores the article 2. The article 2 may be transported from or to the devices 5.

The transport facility 1 shown in FIG. 1 includes a controller 7 that controls the movable body 10 (multiple movable bodies 10 in this example). The controller 7 includes an arithmetic processor such as a central processing unit (CPU) and a peripheral circuit such as a memory. The functions of the controller 7 are implemented by hardware such as the arithmetic processor and a program executable on the hardware cooperating with each other. The controller 7 assigns a task for transporting the article 2 to any of the movable bodies 10. The movable body 10 with the task assigned is controlled to perform the task. For example, the movable body 10 with a transport task assigned to transport the article 2 from a transport origin to a transport destination is controlled to move to the transport origin specified by the transport task to receive the article 2 and then move to the transport destination specified by the transport task to transfer the article 2.

The controller 7 tracks the current position of the movable body 10 (the current positions of the movable bodies 10 in the present embodiment). In the present embodiment, each movable body 10 identifies its current position. The controller 7 obtains information indicating the current position of each movable body 10 from the movable body 10. Although not described in detail, for example, multiple detectable members storing position information (e.g., one-or two-dimensional codes or radio frequency tags) are installed at multiple positions along the travel path 3. The movable body 10 identifies its current position by reading the position information stored in the detectable members. The movable body 10 identifies its current position based on, for example, the read position information and the distance by which the movable body 10 has traveled after reading the position information. The movable body 10 may identify its current position based on an output from a positioning device such as a global navigation satellite system (GNSS) receiver.

In the example shown in FIG. 1, the wireless communication system 30 performs communication between the controller 7 and the movable bodies 10. The wireless communication system 30 connects the wireless access points 31 and the controller 7 to allow them to perform communication. More specifically, the wireless communication system 30 includes a device (e.g., a LAN cable or a hub) to build a communication network between the wireless access points 31 and the controller 7. The wireless access points 31 relay communication between the movable bodies 10 and the controller 7.

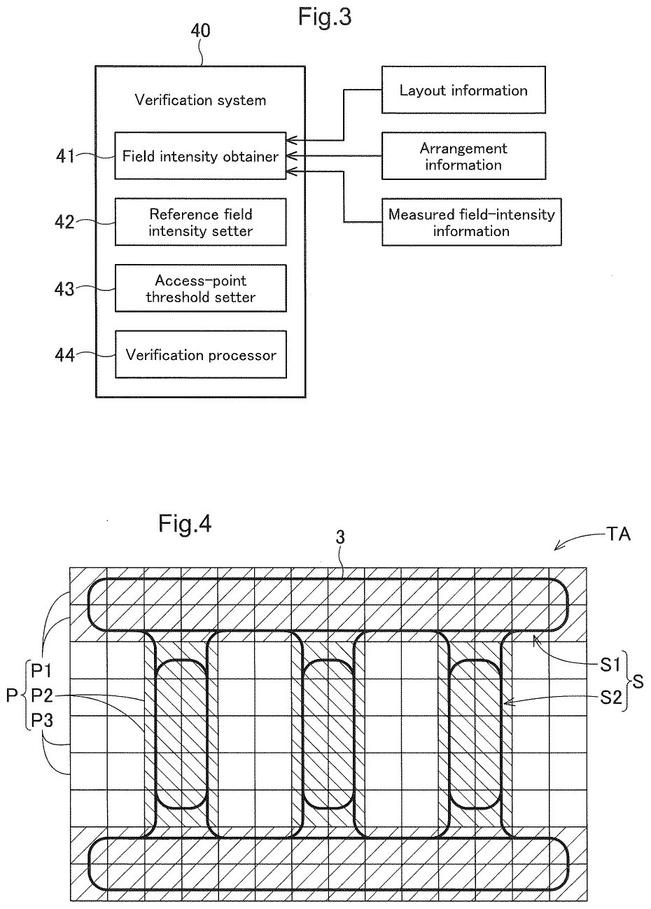

The structure of the verification system 40 will now be described. As shown in FIG. 3, the verification system 40 includes a field intensity obtainer 41, a reference field intensity setter 42, and a verification processor 44. In the present embodiment, the verification system 40 further includes an access-point threshold setter 43. These functional components (41 to 44) included in the verification system 40 are at least logically distinguishable from one another, and may not be physically separate from one another. The verification system 40 (specifically, the control device included in the verification system 40) includes an arithmetic processor and a peripheral circuit. The functions of the functional components of the verification system 40 are implemented by hardware such as the arithmetic processor and a program executable on the hardware cooperating with each other. The verification system 40 may be implemented by multiple devices that can communicate with one another, rather than a single device (e.g., a computer such as a personal computer or a workstation).

The field intensity obtainer 41 obtains observation-site field-intensity information. Obtaining the observation-site field-intensity information corresponds to obtaining observation-site field-intensity information included in a verification method for the wireless communication system 30. The observation-site field-intensity information is obtained to implement a field intensity information obtaining function. Although described in detail later, the observation-site field-intensity information is information indicating the radio field intensity at each observation site P. The target area TA includes multiple observation sites P. The observation sites P are set manually by, for example, an operator or automatically by the verification system 40. When the observation sites P are set automatically, the observation sites P are set by the verification system 40 based on, for example, information indicating the shape of the target area TA and information indicating the travel path 3 of the movable bodies 10.

As in the example shown in FIG. 1, when the movable bodies 10 move along the predetermined travel path 3, the observation sites P may be set at least along the travel path 3. Although the observation sites P may be set at positions other than along the travel path 3, the observation sites P may be set along the travel path 3 alone. For a travel path 3 of the movable bodies 10 not predetermined but freely settable, the observation sites P may be set at least along a possible travel path 3, when such a travel path 3 can be specified substantially.

The observation sites P are set at, for example, multiple mesh cells resulting from division (meshing) of the target area TA. For example, as in the example shown in FIG. 4, the observation sites P are set at multiple mesh cells resulting from two-dimensional division (division in two horizontal directions perpendicular to each other in this example) of the target area TA. In this case, the height (position in the vertical direction) of each observation site P is set at, for example, the height of the travel path 3 (or the height of the movable body 10 moving along the travel path 3). FIG. 4 shows three types of observation sites P, or first sites P1, second sites P2, and third sites P3 (described later).

In the example shown in FIG. 4, each observation site P has the same area as the corresponding mesh cell, but may have a smaller area than the mesh cell. In this case, the observation site P is, for example, a representative point (e.g., a center point) in each mesh. In the example shown in FIG. 4, the entire target area TA is equally divided, but the target area TA may be divided into mesh cells with different sizes based on the location in the target area TA. The observation sites P may not be set across the target area TA, and may be set at least in areas of the target area TA in which the wireless communication system 30 and the movable bodies 10 perform wireless communication (e.g., in an area in which the travel path 3 is disposed). More specifically, the observation sites P may be unevenly distributed based on the features (e.g., whether the travel path 3 is disposed) of each area of the target area TA. For example, the observation sites P may be set at, among the multiple mesh cells, mesh cells including the travel path 3. In this case, the observation sites P are set along the travel path 3 alone.

As described above, the observation-site field-intensity information indicates the radio field intensity at each observation site P. More specifically, the observation-site field-intensity information indicates at least one of a predictive value of the radio field intensity provided from each of the wireless access points 31 calculated for each observation site P or a measurement value of the radio field intensity provided from each of the wireless access points 31 measured for each observation site P. When the observation-site field-intensity information indicates the above predictive value, the predictive value is provided to all the observation sites P. When the observation-site field-intensity information indicates the above measurement value, the measurement value is provided to all the observation sites P. The observation-site field-intensity information indicating both the predictive value and the measurement value includes the three cases below. In the first case, the predictive value and the measurement value are both provided to all the observation sites P. In the second case, the predictive value and the measurement value are both provided to at least one of the observation sites P whereas either the predictive value or the measurement value is provided to the other observation sites P. In the third case, the predictive value is provided to at least one of the observation sites P whereas the measurement value is provided to the other observation sites P. Each observation site P provided with both the predictive and measurement values may use, for example, one of the predictive value or the measurement value as the radio field intensity at the observation site P or use a value based on both the predictive and measurement values (e.g., the mean value of these) as the radio field intensity at the observation site P.

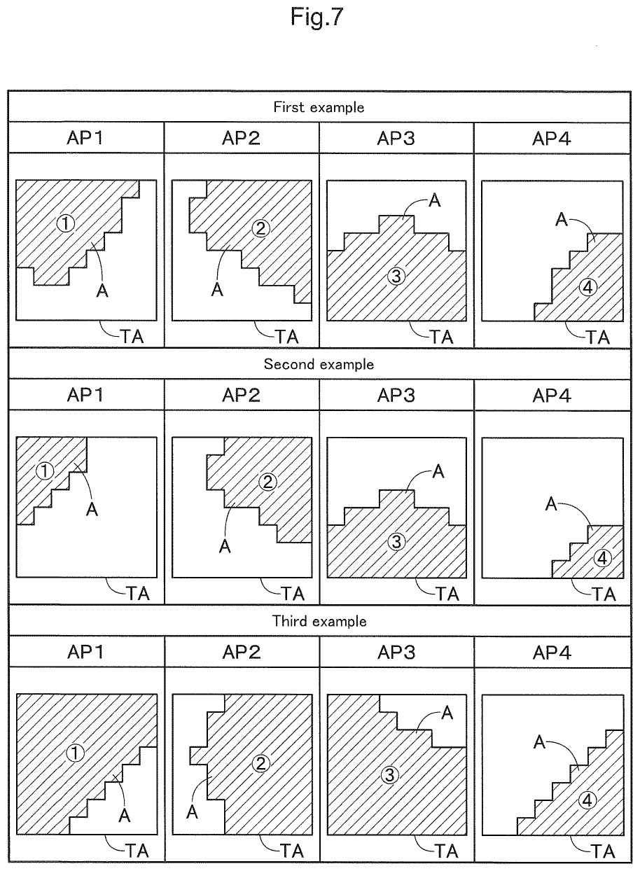

The predictive value or the measurement value is provided in a manner distinguishable at each wireless access point 31. This allows a communication area A (an area provided with a radio field intensity higher than or equal to the reference radio field intensity) to be defined for each wireless access point 31 based on the observation-site field-intensity information, as shown in FIG. 7 (referred to later). FIG. 7 shows three examples (a first example, a second example, and a third example) of the communication area A for each of four wireless access points 31, or a first access point AP1, a second access point AP2, a third access point AP3, and a fourth access point AP4.

The predictive value of the radio field intensity included in the observation-site field-intensity information is calculated based on layout information and arrangement information. The intensity of radio waves provided to each observation site P for each wireless access point 31 is calculated using a propagation model to obtain the predictive value of the radio field intensity for each observation site P. The layout information includes information indicating the shape (two-dimensional or three-dimensional shape) of the target area TA and information indicating the positions of objects that affect radio wave propagation in the target area TA (e.g., the rails 4 defining the travel path 3, the devices 5, and a wall 6 in the example shown in FIG. 1). The arrangement information indicates the arrangement of the wireless access points 31. The arrangement information may indicate the arrangement of the wireless access points 31 for simulation or the arrangement of the wireless access points 31 that are actually installed. In the present embodiment, the rails 4, the devices 5, and the wall 6 each correspond to an object.

When the observation-site field-intensity information obtained by the field intensity obtainer 41 includes the predictive value of the radio field intensity, the field intensity obtainer 41 obtains a predictive value of the radio field intensity resulting from calculation or obtains layout information and arrangement information to obtain a predictive value of the radio field intensity through calculation based on the obtained layout information and arrangement information. FIG. 3 shows the latter case. In this case, the layout information and the arrangement information are transmitted to the field intensity obtainer 41 from, for example, a computer (e.g., a computer for displaying results of verification performed by the verification system 40) operated by an operator. The field intensity obtainer 41 may obtain the layout information and the arrangement information from the controller 7 (refer to FIG. 1).

When the observation-site field-intensity information obtained by the field intensity obtainer 41 includes the measurement value of the radio field intensity, the field intensity obtainer 41 obtains measured field-intensity information indicating the measurement value of the radio field intensity, as shown in FIG. 3. The measurement value of the radio field intensity may be measured by the movable bodies 10 (specifically, the communication module mounted on each movable body 10) or a device other than the movable bodies 10. When the measurement value is measured by the movable bodies 10, for example, the measurement value of the radio field intensity for each observation site P may be obtained with reference to a log storage device that stores a log of the position of each movable body 10, a log of the wireless access points 31 to which the movable bodies 10 are connected, and a log of the intensity of radio waves received by the movable bodies 10 from the wireless access points 31 to which the movable bodies 10 are connected. The log storage device is in, for example, the controller 7 (refer to FIG. 1).

The reference field intensity setter 42 sets a reference radio field intensity. Setting the reference radio field intensity corresponds to setting a reference radio field intensity included in the verification method for the wireless communication system 30. The reference radio field intensity is set to implement a reference field intensity setting function. The reference field intensity setter 42 sets the reference radio field intensity that is a reference value of the radio field intensity provided from the wireless communication system 30 at each observation site P in the target area TA. The reference radio field intensity is defined as, for example, a lower limit of an allowable radio field intensity. The reference field intensity setter 42 sets, as the reference radio field intensity, a preset value or a value input by an operator, for example.

The same value or different values may be set as the reference radio field intensity for all the observation sites P. For example, different reference radio field intensity values may be set based on the features of each observation site P. Examples of the features of each observation site P include whether the observation site P is along the travel path 3, along a main section of the travel path 3, or along a section other than the main section of the travel path 3. For example, the reference field intensity setter 42 may set multiple levels for sections S of the travel path 3 and may set the reference radio field intensity to different values based on the levels. These levels are determined based on, for example, the speed of movement of the movable bodies 10 or the traffic of the movable bodies 10.

More specifically, the travel path 3 shown in FIG. 4 includes, as the sections S, a first section S1 not passing through the devices 5 (refer to FIG. 1) and a second section S2 passing through the devices 5. In this case, the first section S1 serves as a main section, and the second section S2 serves as a section other than the main section. When the movable bodies 10 move at a higher speed (average movement speed) in the first section S1, a higher radio field intensity may be used in the first section S1. The reference field intensity setter 42 may thus set multiple levels corresponding to the movement speed of the movable bodies 10 for the sections S of the travel path 3 and set higher reference radio field intensity values for higher movement speeds of the movable body 10 based on the levels. In this case, the movement speed is higher at the level that is set for the first section S1 than at the level that is set for the second section S2. A higher reference radio field intensity is set for the first sites P1 that are the observation sites P along the first section S1 than for the second sites P2 that are the observation sites P along the second section S2.

In FIG. 4, the observation sites P not along the travel path 3 are defined as the third sites P3. The third sites P3 are left blank, and the first sites P1 and the second sites P2 are hatched with different patterns to be distinguished from one another. A lower reference radio field intensity may be set for the third sites P3 than for the second sites P2. The reference radio field intensity set for the third sites P3 may be zero, or in other words, the third sites P3 may be excluded from the observation sites P.

In the example shown in FIG. 4, with more traffic (average traffic) of the movable bodies 10 in the first section S1, a higher radio field intensity may be used in the first section S1. The reference field intensity setter 42 may thus set multiple levels corresponding to the traffic of the movable bodies 10 for the sections S of the travel path 3 and set higher reference radio field intensity values for more traffic of the movable bodies 10 based on the levels. In this case, the traffic is more at the level that is set for the first section S1 than at the level that is set for the second section S2. A higher reference radio field intensity is set for the first sites P1 that are the observation sites P along the first section S1 than for the second sites P2 that are the observation sites P along the second section S2.

The access-point threshold setter 43 sets an access-point threshold. Setting the access-point threshold corresponds to setting a threshold for the number of access points included in the verification method for the wireless communication system 30. The access-point threshold is set to implement an access-point threshold setting function. The access-point threshold setter 43 sets the access-point threshold that is a threshold for the number of wireless access points 31 that provide a radio field intensity higher than or equal to the reference radio field intensity at each observation site P. Although the access-point threshold may be set to 1, the value of 2 or greater may be set for stable communication. The same access-point threshold may be set for all the observation sites P or different thresholds may be set for different observation sites P. For example, the access-point threshold setter 43 sets, as the access-point threshold, a preset value or a value manually input by, for example, an operator.

The verification processor 44 performs a verification process for the arrangement of the wireless access points 31. Performing the verification process corresponds to performing a verification process included in the verification method for the wireless communication system 30. The verification process is performed to implement a verification function. The verification processor 44 performs the verification process for the arrangement of the wireless access points 31 based on the observation-site field-intensity information. The verification process includes a removable-access-point extraction process described below. The verification process may include processes other than the removable-access-point extraction process. For example, the verification process may include extracting a site at which a wireless access point 31 is to be added or extracting a site to which the wireless access point 31 is to be moved.

The removable-access-point extraction process is a process for extracting, from the wireless access points 31, a removable wireless access point 31 that is removable while satisfying a field intensity condition. The field intensity condition is satisfied when the radio field intensity at all the observation sites P is higher than or equal to the reference radio field intensity. Although a removable wireless access point 31 may be extracted after a wireless access point 31 is moved or added, in the present embodiment, a removable wireless access point 31 is extracted without a wireless access point 31 moved or added in the removable-access-point extraction process.

In the present embodiment, a removable wireless access point 31 is extracted in the removable-access-point extraction process to satisfy, in addition to the field intensity condition, an access-point condition. The access-point condition is satisfied when the number of wireless access points 31 providing a radio field intensity higher than or equal to the reference radio field intensity is higher than or equal to the access-point threshold at all the observation sites P. When the access-point threshold set for all the observation sites P is 1, the field intensity condition is satisfied, and thus the access-point condition is satisfied. In this case, extracting a wireless access point 31 that is removable while satisfying the field intensity condition allows extracting a wireless access point 31 that is removable while satisfying both the field intensity condition and the access-point condition.

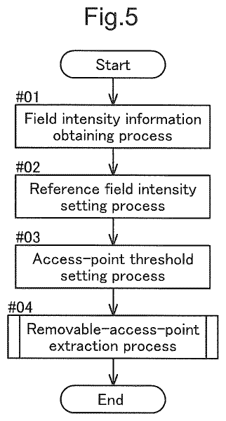

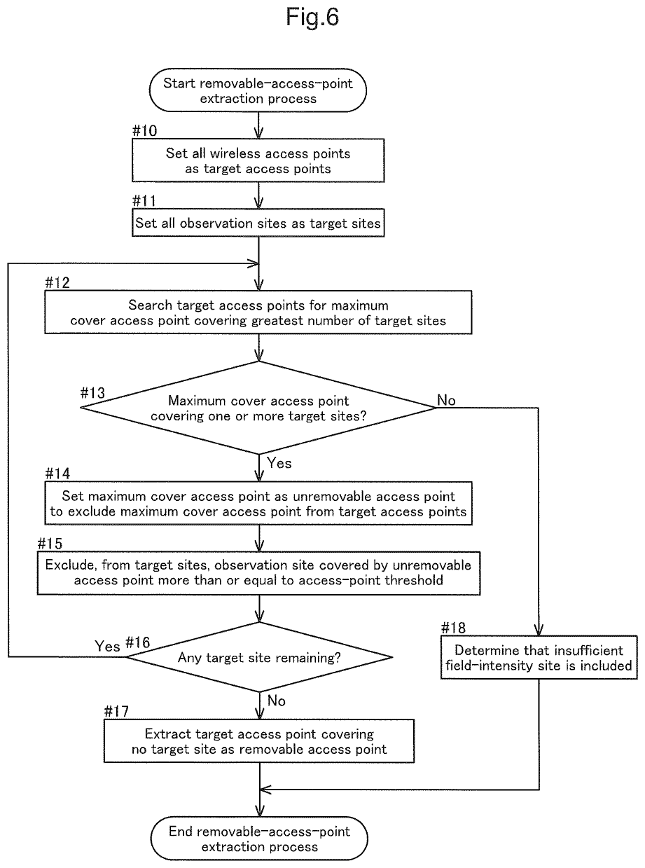

With reference to FIGS. 5 and 6, a preprocess and the verification process in the present embodiment will be described below. As shown in FIG. 5, the field intensity obtainer 41 performs, as the preprocess, a field intensity information obtaining process for obtaining the observation-site field-intensity information (step #01). The reference field intensity setter 42 performs, as the preprocess, a reference field intensity setting process for setting the reference radio field intensity at each observation site P (step #02). In the present embodiment, the access-point threshold setter 43 performs, as the preprocess, an access-point threshold setting process for setting an access-point threshold at each observation site P (step #03). The order in which the three steps (steps #01 to #03) are performed as shown in FIG. 5 is an example. The three steps may be performed in any order, or two or three steps may be performed in parallel. After the preprocess, the verification processor 44 performs a removable-access-point extraction process as the verification process (step #04).

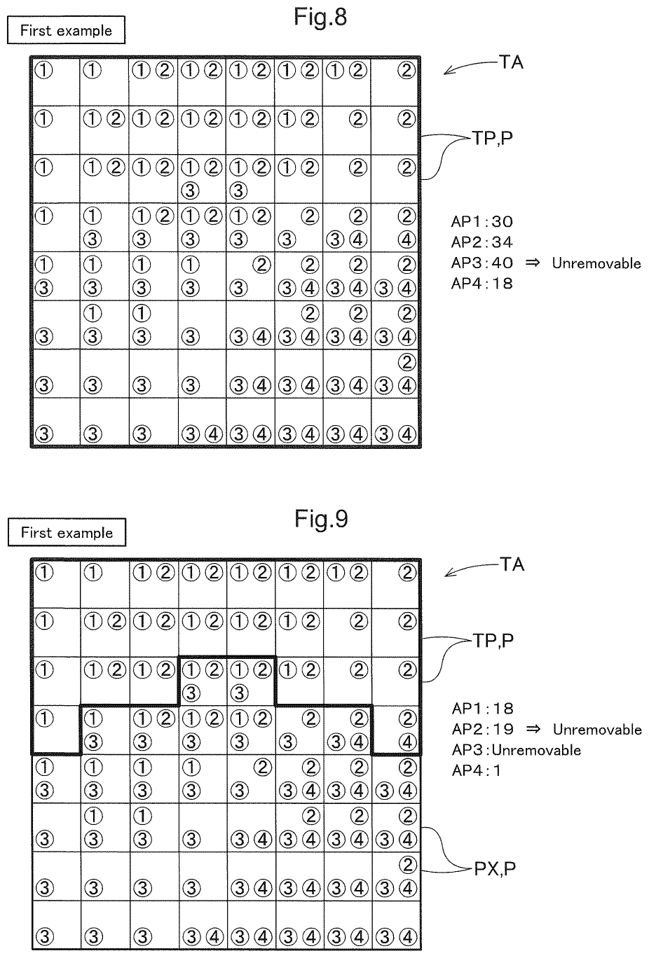

In the present embodiment, as shown in FIG. 6, the verification processor 44 repeatedly performs, in the removable-access-point extraction process, an unremovable-access-point setting process and a target site setting process from the state in which all the wireless access points 31 are set as target access points and all the observation sites P are set as target sites TP (refer to, for example, FIG. 8). More specifically, the verification processor 44 sets all the wireless access points 31 as the target access points (step #10) and sets all the observation sites P as the target sites TP (step #11). The order in which these two steps (steps #10 and #11) are performed as shown in FIG. 6 is an example. The two steps may be performed in any order, or may be performed in parallel.

The unremovable-access-point setting process is a process for setting an unremovable access point to exclude the unremovable access point from the target access points (steps #12 to #14). The unremovable access point is, among the wireless access points 31 set as the target access points, a wireless access point 31 (hereafter referred to as a maximum cover access point) providing a radio field intensity higher than or equal to the reference radio field intensity to the greatest number of target sites TP that are one or more target sites TP. More specifically, the verification processor 44 searches the target access points for the maximum cover access point that covers the greatest number of target sites TP (step #12). In this example, covering indicates providing a radio field intensity higher than or equal to the reference radio field intensity. When the maximum cover access point covers one or more target sites TP (Yes in step #13), the verification processor 44 sets the maximum cover access point as an unremovable access point to exclude the maximum cover access point from the target access points (step #14).

The target site setting process is a process for setting, each time an unremovable access point is newly set, a radio-wave covered site PX to exclude the radio-wave covered site PX from the target sites TP (step #15). The radio-wave covered site PX is, among the observation sites P set as the target sites TP, an observation site P provided with a radio field intensity higher than or equal to the reference radio field intensity by the unremovable access point more than or equal to the access-point threshold. More specifically, after setting the maximum cover access point as the unremovable access point (step #14), the verification processor 44 excludes, from the target sites TP, an observation site P covered by the unremovable access point more than or equal to the access-point threshold (step #15).

Initially, all the observation sites P are target sites TP. As the removable-access-point extraction process progresses (specifically, as some of the observation sites P are excluded from the target sites TP through the target site setting process), the number of target sites TP decreases gradually. While any target site TP remains (Yes in step #16), the verification processor 44 repeatedly performs the unremovable-access-point setting process and the target site setting process (steps #12 to #15). In the unremovable-access-point setting process, the verification processor 44 extracts, as a removable wireless access point 31 (hereafter referred to as a removable access point), a target access point not providing a radio field intensity higher than or equal to the reference radio field intensity to any target site TP (step #17). More specifically, when no target site TP remains (No in step #16), the verification processor 44 extracts a target access point (in other words, a wireless access point 31 set as a target access point at the time point) covering no target site TP as a removable access point (step #17). When no target site TP remains (No in step #16) and no target access point remains (in other words, when all the wireless access points 31 are set as unremovable access points), the verification processor 44 determines that no access point is removable.

The arrangement of the wireless access points 31 to be verified may include an observation site P not provided with a radio field intensity higher than or equal to the reference radio field intensity by wireless access points 31 more than or equal to the access-point threshold. In this case, by the time at which no target sites TP remains (Yes in step #16), the verification processor 44 determines that the maximum cover access point does not cover one or more target sites TP (No in step #13). More specifically, the verification processor 44 determines that the number of target sites TP cannot be reduced (or the number of radio-wave covered sites PX cannot be increased) with the remaining wireless access points 31 not determined as unremovable access points at that time. In this case (No in step #13), the verification processor 44 determines that the multiple observation sites P include an insufficient field-intensity site PY (step #18), and ends the removable-access-point extraction process. In step #18, the verification processor 44 determines the observation site P set as a target site TP at the time to be the insufficient field-intensity site PY.

In the present embodiment, when the verification processor 44 determines that the multiple observation sites P include the insufficient field-intensity site PY based on the observation-site field-intensity information, the verification process includes, for example, a process for generating correction data for adding a new wireless access point 31 at a position at which the new wireless access point 31 can provide a radio field intensity higher than or equal to the reference radio field intensity to the insufficient field-intensity site PY. The insufficient field-intensity site PY is an observation site P not provided with a radio field intensity higher than or equal to the reference radio field intensity (in the present embodiment, an observation site P not provided with a radio field intensity higher than or equal to the reference radio field intensity by the wireless access points 31 more than or equal to the access-point threshold) This correction data is, for example, data for identifying the insufficient field-intensity site PY or data of corrected arrangement information to which the wireless access point 31 is added at the position described above. The verification system 40 performs the field intensity information obtaining process and the verification process (removable-access-point extraction process) again using, for example, the corrected arrangement information.

Specific examples of the removable-access-point extraction process will now be described with reference to FIGS. 7 to 19. In the examples, the removable-access-point extraction process is performed on four wireless access points 31 (a first access point AP1, a second access point AP2, a third access point AP3, and a fourth access point AP4). FIG. 7 shows communication areas A of the four wireless access points 31 in three examples (a first example, a second example, and a third example). In these examples, as shown in FIG. 8 or other figures, the target area TA is divided into 64 (=8×8) mesh cells, in each of which an observation site P is set. Each communication area A shown in FIG. 7 indicates an area in which the observation sites P provided with a radio field intensity higher than or equal to the reference radio field intensity are arranged. The communication area A is determined for each wireless access point 31 based on the observation-site field-intensity information.

In FIGS. 8 to 19, the numerals (encircled numerals) in each observation site P (specifically, in the mesh cells in each of which an observation site P is set) indicate the wireless access points 31 providing a radio field intensity higher than or equal to the reference radio field intensity to the observation site P. More specifically, the observation sites P including the encircled 1 are provided with a radio field intensity higher than or equal to the reference radio field intensity by the first access point AP1. The observation sites P including the encircled 2 are provided with a radio field intensity higher than or equal to the reference radio field intensity by the second access point AP2. The observation sites P including the encircled 3 are provided with a radio field intensity higher than or equal to the reference radio field intensity by the third access point AP3. The observation sites P including the encircled 4 are provided with a radio field intensity higher than or equal to the reference radio field intensity by the fourth access point AP4. The observation sites P provided with a radio field intensity higher than or equal to the reference radio field intensity by multiple wireless access points 31 include multiple encircled numerals.

FIGS. 8 to 19 show, on the right, the number of target sites TP covered by each of the wireless access points 31 (AP1 to AP4) in the shown state. In FIGS. 8 to 19, the observation sites P set as target sites TP among the multiple observation sites P are surrounded by a thick frame to be distinguished from the observation sites P set as radio-wave covered sites PX and excluded from target sites TP.

### FIRST EXAMPLE

FIGS. 8 to 11 are diagrams describing the removable-access-point extraction process in the first example (refer to FIG. 7). In the first example, the access-point threshold is set to 1 for all the observation sites P. In the example described below, the steps in FIG. 6 are also referred to.

First, as shown in FIG. 8, all the four wireless access points 31 (AP1 to AP4) are set as target access points (step #10), and all the 64 observation sites P are set as target sites TP (step #11). In this state, the third access point AP3 is selected as a maximum cover access point (step #12). The third access point AP3 covers one or more (=40) target sites TP (Yes in step #13). The third access point AP3 is thus set as an unremovable access point and excluded from the target access points (step #14). The observation sites P covered by the unremovable access point more than or equal to the access-point threshold (the observation sites P covered by the third access point AP3 in this example) are set as radio-wave covered sites PX and excluded from the target sites TP (step #15), as in the state shown in FIG. 9.

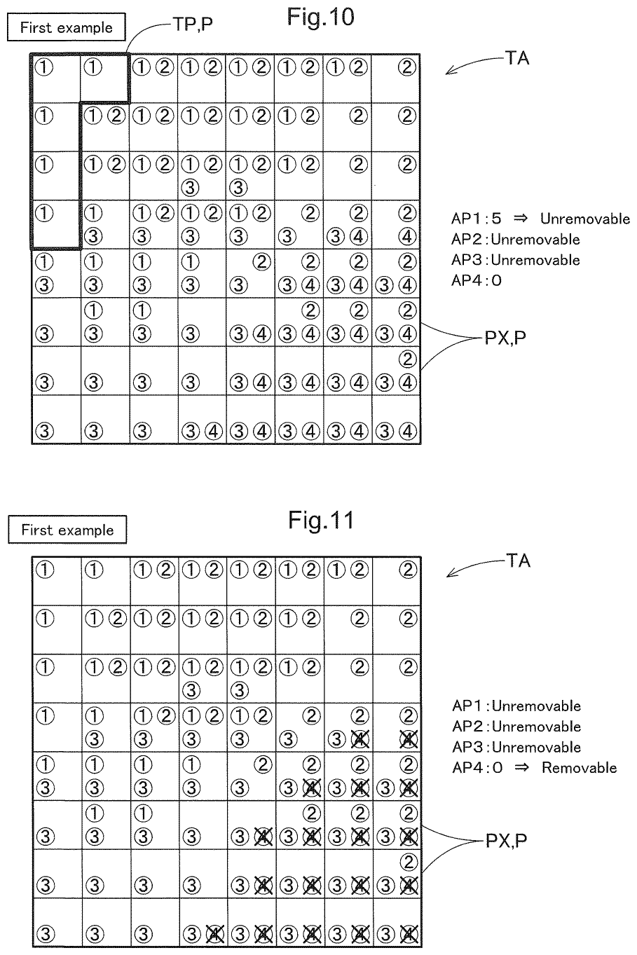

In the state in FIG. 9, target sites TP still remain (Yes in step #16), and three wireless access points 31 (AP1, AP2, and AP4) are set as target access points. After the exclusion of at least one observation site P from the target sites TP, the target sites TP covered by the three wireless access points 31 (AP1, AP2, and AP4) are fewer than in the state in FIG. 8. The second access point AP2 is then selected as a maximum cover access point (step #12). The second access point AP2 covers one or more (=19) target sites TP (Yes in step #13) and is set as an unremovable access point and excluded from the target access points (step #14). The observation sites P covered by the unremovable access point more than or equal to the access-point threshold (the observation sites P covered by the second access point AP2 in this example) are set as radio-wave covered sites PX and excluded from the target sites TP (step #15), as in the state shown in FIG. 10.

In the state in FIG. 10, target sites TP still remain (Yes in step #16), and two wireless access points 31 (AP1 and AP4) are set as target access points. The first access point AP1 is then selected as a maximum cover access point (step #12). The first access point AP1 covers one or more (=5) target sites TP (Yes in step #13) and thus is set as an unremovable access point and excluded from the target access points (step #14). The observation sites P covered by the unremovable access point more than or equal to the access-point threshold (the observation sites P covered by the first access point AP1 in this example) are set as radio-wave covered sites PX and excluded from the target sites TP (step #15), as in the state shown in FIG. 11.

In the state in FIG. 11, no target site TP remains (No in step #16), and one wireless access point 31 (AP4) is set as a target access point. Thus, the fourth access point AP4, which covers no target site TP, is extracted as a removable access point (step #17). As clear from FIG. 11, when the fourth access point AP4 is removed (refer to the cross marks in FIG. 11), all the observation sites P are provided with a radio field intensity higher than or equal to the reference radio field intensity by the wireless access points 31 more than or equal to the access-point threshold (one or more in this example).

### SECOND EXAMPLE

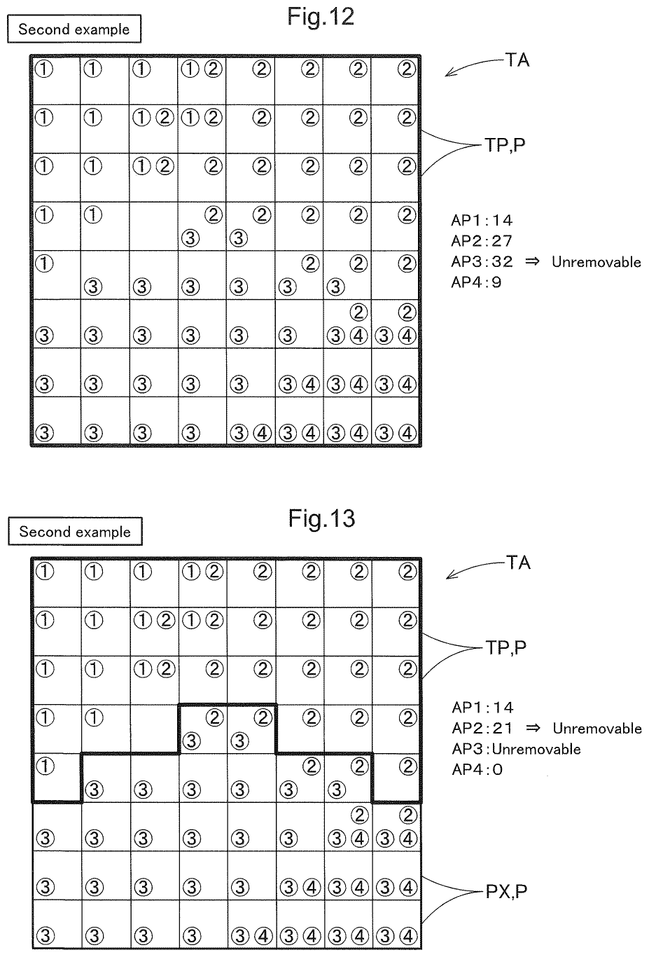

FIGS. 12 to 15 are diagrams describing the removable-access-point extraction process in the second example (refer to FIG. 7). In the second example, the access-point threshold is set to 1 for all the observation sites P. In the example described below, the steps in FIG. 6 are also referred to.

First, as shown in FIG. 12, all the four wireless access points 31 (AP1 to AP4) are set as target access points (step #10), and all the 64 observation sites P are set as target sites TP (step #11). In this state, the third access point AP3 is selected as a maximum cover access point (step #12). The third access point AP3 covers one or more (=32) target sites TP (Yes in step #13), and thus is set as an unremovable access point and excluded from the target access points (step #14). The observation sites P covered by the unremovable access point more than or equal to the access-point threshold (the observation sites P covered by the third access point AP3 in this example) are set as radio-wave covered sites PX and excluded from the target sites TP (step #15), as in the state shown in FIG. 13.

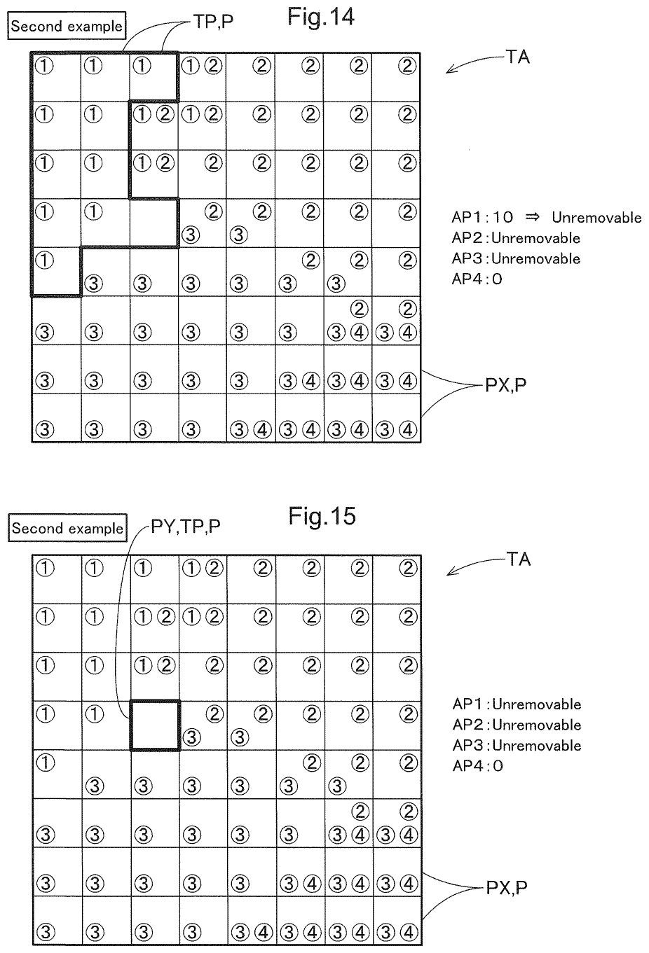

In the state in FIG. 13, target sites TP still remain (Yes in step #16), and three wireless access points 31 (AP1, AP2, and AP4) are set as target access points. The second access point AP2 is then selected as a maximum cover access point (step #12). The second access point AP2 covers one or more (=21) target sites TP (Yes in step #13), and is thus set as an unremovable access point and excluded from the target access points (step #14). The observation sites P covered by the unremovable access point more than or equal to the access-point threshold (the observation sites P covered by the second access point AP2 in this example) are set as radio-wave covered sites PX and excluded from the target sites TP (step #15), as in the state shown in FIG. 14.

In the state in FIG. 14, target sites TP still remain (Yes in step #16), and two wireless access points 31 (AP1 and AP4) are set as target access points. The first access point AP1 is then selected as a maximum cover access point (step #12). The first access point AP1 covers one or more (=10) target sites TP (Yes in step #13), and thus is set as an unremovable access point and excluded from the target access points (step #14). The observation sites P covered by the unremovable access point more than or equal to the access-point threshold (the observation sites P covered by the first access point AP1 in this example) are set as radio-wave covered sites PX and excluded from the target sites TP (step #15), as in the state shown in FIG. 15.

In the state in FIG. 15, a target site TP still remains (Yes in step #16), and one wireless access point 31 (AP4) is set as a target access point. The fourth access point AP4 is then selected as a maximum cover access point (step #12). The fourth access point AP4 does not cover one or more (covers 0) target sites TP (No in step #13). The target site TP is thus determined as an insufficient field-intensity site PY (step #18).

### THIRD EXAMPLE

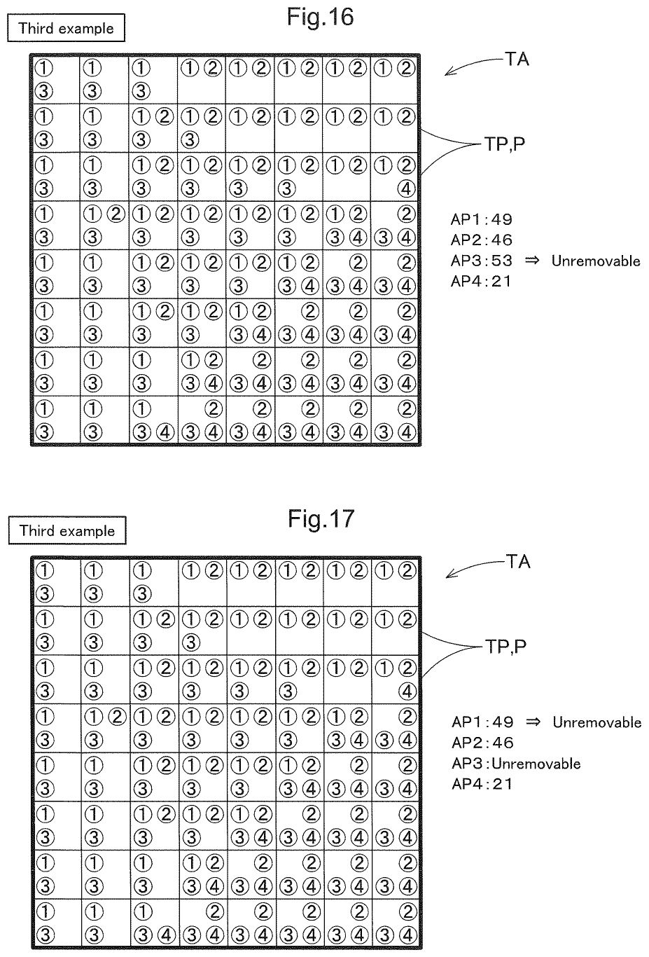

FIGS. 16 to 19 are diagrams describing the removable-access-point extraction process in the third example (refer to FIG. 7). In the third example, the access-point threshold is set to 2 for all the observation sites P. In the example described below, the steps in FIG. 6 are also referred to.

First, as shown in FIG. 16, all the four wireless access points 31 (AP1 to AP4) are set as target access points (step #10), and all the 64 observation sites P are set as target sites TP (step #11). In this state, the third access point AP3 is selected as a maximum cover access point (step #12). The third access point AP3 covers one or more (=53) target sites TP (Yes in step #13), and thus is set as an unremovable access point and excluded from the target access points (step #14). In this state, one wireless access point 31, which is fewer than the access-point threshold, is set as an unremovable access point, and thus no observation site P is covered by unremovable access points more than or equal to the access-point threshold. Thus, no observation site P is excluded from the target sites TP, as in the state shown in FIG. 17.

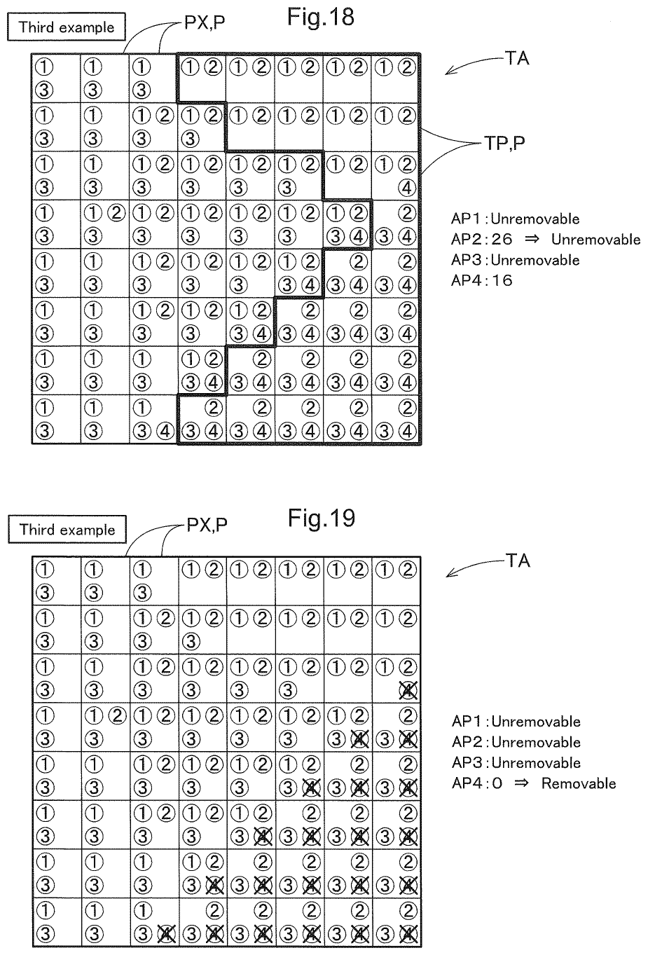

In the state in FIG. 17, target sites TP still remain (Yes in step #16), and three wireless access points 31 (AP1, AP2, and AP4) are set as target access points. The first access point AP1 is then selected as a maximum cover access point (step #12). The first access point AP1 covers one or more (=49) target sites TP (Yes in step #13), and is thus set as an unremovable access point and excluded from the target access points (step #14). The observation sites P covered by the unremovable access points more than or equal to the access-point threshold (the observation sites P covered by the first access point AP1 and the third access point AP3 in this example) are set as radio-wave covered sites PX and excluded from the target sites TP (step #15), as in the state shown in FIG. 18.

In the state in FIG. 18, target sites TP still remain (Yes in step #16), and two wireless access points 31 (AP2 and AP4) are set as target access points. The second access point AP2 is then selected as a maximum cover access point (step #12). The second access point AP2 covers one or more (=26) target sites TP (Yes in step #13), and is thus set as an unremovable access point and excluded from the target access points (step #14). The observation sites P covered by the unremovable access points more than or equal to the access-point threshold (the observation sites P covered by at least one of the first access point AP1 or the third access point AP3 and by the second access point AP2) are set as radio-wave covered sites PX and excluded from the target sites TP (step #15), as in the state shown in FIG. 19.

In the state in FIG. 19, no target site TP remains (No in step #16), and one wireless access point 31 (AP4) is set as a target access point. Thus, the fourth access point AP4, which is a target access point that covers no target site TP, is extracted as a removable access point (step #17). As clear from FIG. 19, when the fourth access point AP4 (refer to the cross marks in FIG. 19) is removed, all the observation sites P are still provided with a radio field intensity higher than or equal to the reference radio field intensity by the wireless access points 31 more than or equal to the access-point threshold (two or more in this example).

The embodiments described herein are merely illustrative in all aspects and may be modified variously as appropriate without departing from the spirit and scope of the disclosure.

### Overview of Present Embodiment

An overview of the verification system according to the embodiments described above is provided below.

The verification system is a system for a wireless communication system. The wireless communication system includes a plurality of wireless access points arranged to provide radio waves to a target area to perform wireless communication with a movable body movable in the target area. The verification system includes a reference field intensity setter, a field intensity obtainer, and a verification processor. The reference field intensity setter sets a reference radio field intensity that is a reference value of a radio field intensity provided from the wireless communication system at each of a plurality of observation sites in the target area. The field intensity obtainer obtains observation-site field-intensity information indicating at least one of a predictive value of the radio field intensity provided from each of the plurality of wireless access points or a measurement value of the radio field intensity provided from each of the plurality of wireless access points. The predictive value is calculated for each of the plurality of observation sites based on layout information and arrangement information. The measurement value is measured for each of the plurality of observation sites. The layout information includes information indicating a shape of the target area and information indicating a position of an object affecting propagation of the radio waves in the target area. The arrangement information indicates arrangement of the plurality of wireless access points. The verification processor performs a verification process for the arrangement of the plurality of wireless access points based on the observation-site field-intensity information. The verification process includes a removable-access-point extraction process for extracting, from the plurality of wireless access points, a removable wireless access point that is removable while satisfying a field intensity condition. The field intensity condition is satisfied when the radio field intensity at all the plurality of observation sites is higher than or equal to the reference radio field intensity.

This structure performs the verification process for the arrangement of the plurality of wireless access points based on the observation-site field-intensity information indicating the radio field intensity at each observation site. This allows a removable wireless access point to be extracted appropriately in the removable-access-point extraction process included in the verification process. The observation-site field-intensity information indicates at least one of the predictive value of the radio field intensity calculated for each observation site or the measurement value of the radio field intensity measured for each observation site. Thus, removable wireless access points can be extracted appropriately independently of whether the wireless access points are actually installed. As described above, the structure can verify the arrangement of multiple wireless access points and appropriately extract a wireless access point that is removable.

The verification system may further include an access-point threshold setter that sets, for each of the plurality of observation sites, an access-point threshold that is a threshold for the number of wireless access points providing the radio field intensity higher than or equal to the reference radio field intensity. In the removable-access-point extraction process, the removable wireless access point is extracted to satisfy the field intensity condition and an access-point condition. The access-point condition is satisfied when the number of wireless access points providing the radio field intensity higher than or equal to the reference radio field intensity is greater than or equal to the access-point threshold at all the plurality of observation sites.

This structure can extract the removable wireless access point in the removable-access-point extraction process while satisfying the access-point condition at all the multiple observation sites in addition to the field intensity condition. The structure can thus extract the removable wireless access point appropriately while achieving stable wireless communication at all the observation sites.

In the removable-access-point extraction process, the verification processor may repeatedly perform an unremovable-access-point setting process and a target site setting process from a state in which all the plurality of wireless access points are set as target access points and all the plurality of observation sites are set as target sites. The unremovable-access-point setting process may be a process for setting an unremovable access point to exclude the unremovable access point from the target access points. The unremovable access point may be, among the plurality of wireless access points set as the target access points, a wireless access point providing the radio field intensity higher than or equal to the reference radio field intensity to a greatest number of target sites that are one or more of the target sites. The target site setting process may be a process for setting, each time the unremovable access point is newly set, a radio-wave covered site to exclude the radio-wave covered site from the plurality of target sites. The radio-wave covered site may be, among the plurality of observation sites set as the target sites, an observation site provided with the radio field intensity higher than or equal to the reference radio field intensity by the unremovable access point more than or equal to the access-point threshold. In the unremovable-access-point setting process, the verification processor may extract, as the removable wireless access point, a target access point providing none of the target sites with the radio field intensity higher than or equal to the reference radio field intensity.

This structure can extract the removable wireless access point appropriately while preferentially leaving wireless access points providing the radio field intensity higher than or equal to the reference radio field intensity to more observation sites.

The movable body may move along a predetermined travel path. The plurality of observation sites may be at least along the travel path.

This structure can extract the removable wireless access point appropriately while achieving stable wireless communication between the movable body and the wireless access points.

The reference field intensity setter may set a plurality of levels for sections of the travel path, and set the reference radio field intensity to different values based on the plurality of levels.

In this structure, the reference radio field intensity is set to different values based on the levels of the sections when different sections of the travel path use different radio field intensities. The structure can thus extract the removable wireless access point appropriately while achieving stable wireless communication between the movable body and the wireless access points.

The verification process may include generating, in response to the plurality of observation sites being determined to include an insufficient field-intensity site based on the observation-site field-intensity information, correction data for adding a new wireless access point at a position at which the new wireless access point provides the radio field intensity higher than or equal to the reference radio field intensity to the insufficient field-intensity site. The insufficient field-intensity site may be, among the plurality of observation sites, an observation site not provided with the radio field intensity higher than or equal to the reference radio field intensity.

When the observation sites include any insufficient field-intensity site, this structure can generate, in the verification process, correction data for adding a new wireless access point to provide a radio field intensity higher than or equal to the reference radio field intensity to the insufficient field-intensity site. Thus, when the observation sites are determined to include any insufficient field-intensity site in the verification process, the arrangement of the wireless access points is corrected using the data to satisfy the field intensity condition at all the observation sites.

The verification system according to one or more embodiments of the disclosure produces at least one of the effects described above.

What is claimed is:

1. A verification system for a wireless communication system, the wireless communication system comprising a plurality of wireless access points arranged to provide radio waves to a target area to perform wireless communication with a movable body movable in the target area, the verification system comprising:
a reference field intensity setter configured to set a reference radio field intensity that is a reference value of a radio field intensity provided from the wireless communication system at each of a plurality of observation sites in the target area;
a field intensity obtainer configured to obtain observation-site field-intensity information indicating at least one of a predictive value of the radio field intensity provided from each of the plurality of wireless access points or a measurement value of the radio field intensity provided from each of the plurality of wireless access points, the predictive value being calculated for each of the plurality of observation sites based on layout information and arrangement information, the measurement value being measured for each of the plurality of observation sites, the layout information comprising information indicating a shape of the target area and information indicating a position of an object affecting propagation of the radio waves in the target area, the arrangement information indicating arrangement of the plurality of wireless access points; and
a verification processor configured to perform a verification process for the arrangement of the plurality of wireless access points based on the observation-site field-intensity information, the verification process comprising a removable-access-point extraction process for extracting, from the plurality of wireless access points, a removable wireless access point that is removable while satisfying a field intensity condition, the field intensity condition being satisfied when the radio field intensity at all the plurality of observation sites is higher than or equal to the reference radio field intensity.

2. The verification system according to claim 1, further comprising:
an access-point threshold setter configured to set, for each of the plurality of observation sites, an access-point threshold that is a threshold for the number of wireless access points providing the radio field intensity higher than or equal to the reference radio field intensity, and
wherein, in the removable-access-point extraction process, the removable wireless access point is extracted to satisfy the field intensity condition and an access-point condition, and the access-point condition is satisfied when the number of wireless access points providing the radio field intensity higher than or equal to the reference radio field intensity is greater than or equal to the access-point threshold at all the plurality of observation sites.

3. The verification system according to claim 2, wherein:
in the removable-access-point extraction process, the verification processor repeatedly performs an unremovable-access-point setting process and a target site setting process from a state in which all the plurality of wireless access points are set as target access points and all the plurality of observation sites are set as target sites,
the unremovable-access-point setting process is a process for setting an unremovable access point to exclude the unremovable access point from the target access points, and the unremovable access point is, among the plurality of wireless access points set as the target access points, a wireless access point providing the radio field intensity higher than or equal to the reference radio field intensity to a greatest number of target sites that are one or more of the target sites,
the target site setting process is a process for setting, each time the unremovable access point is newly set, a radio-wave covered site to exclude the radio-wave covered site from the plurality of target sites, and the radio-wave covered site is, among the plurality of observation sites set as the target sites, an observation site provided with the radio field intensity higher than or equal to the reference radio field intensity by the unremovable access point more than or equal to the access-point threshold, and
in the unremovable-access-point setting process, the verification processor extracts, as the removable wireless access point, a target access point providing none of the target sites with the radio field intensity higher than or equal to the reference radio field intensity.

4. The verification system according to claim 1, wherein:
the movable body moves along a predetermined travel path, and
the plurality of observation sites are at least along the travel path.

5. The verification system according to claim 4, wherein:
the reference field intensity setter sets a plurality of levels for sections of the travel path, and sets the reference radio field intensity to different values based on the plurality of levels.

6. The verification system according to claim 1, wherein:
the verification process comprises generating, in response to the plurality of observation sites being determined to include an insufficient field-intensity site based on the observation-site field-intensity information, correction data for adding a new wireless access point at a position at which the new wireless access point provides the radio field intensity higher than or equal to the reference radio field intensity to the insufficient field-intensity site, and the insufficient field-intensity site is, among the plurality of observation sites, an observation site not provided with the radio field intensity higher than or equal to the reference radio field intensity.

7. A verification method for a wireless communication system comprising a plurality of wireless access points arranged to provide radio waves to a target area to perform wireless communication with a movable body movable in the target area, the method comprising:
setting a reference radio field intensity that is a reference value of a radio field intensity provided from the wireless communication system at each of a plurality of observation sites in the target area;
obtaining observation-site field-intensity information indicating at least one of a predictive value of the radio field intensity provided from each of the plurality of wireless access points or a measurement value of the radio field intensity provided from each of the plurality of wireless access points, the predictive value being calculated for each of the plurality of observation sites based on layout information and arrangement information, the measurement value being measured for each of the plurality of observation sites, the layout information comprising information indicating a shape of the target area and information indicating a position of an object affecting propagation of the radio waves in the target area, the arrangement information indicating arrangement of the plurality of wireless access points; and
performing a verification process for the arrangement of the plurality of wireless access points based on the observation-site field-intensity information, the verification process comprising a removable-access-point extraction process for extracting, from the plurality of wireless access points, a removable wireless access point that is removable while satisfying a field intensity condition, the field intensity condition being satisfied when the radio field intensity at all the plurality of observation sites is higher than or equal to the reference radio field intensity.
